(19) United States
(12) Patent Application Publication
(10) Pub. No.: US 2018/0207642 A1
(43) Pub. Date: Jul. 26, 2018

(54) SIEVE SYSTEM FOR A GRINDING DEVICE, AND GRINDING DEVICE USING THIS TYPE OF SIEVE SYSTEM

(71) Applicant: FREWITT FABRIQUE DE MACHINES SA, Granges-Paccot (CH)

(72) Inventors: Antoine VIRDIS, Ferpicloz (CH); Christophe PASQUIER, Romanens (CH); Glenn CORMINBOEUF, Domdidier (CH)

(21) Appl. No.: 15/533,689

(22) PCT Filed: Dec. 7, 2015
(86) PCT No.: PCT/IB2015/059413

§ 371 Date: Jul. 25, 2017

(30) Foreign Application Priority Data
Dec. 9, 2014 (EP) 14197012.9

(51) Int. Cl. B02C 13/284; B02C 18/06; B07B 1/06; B07B 1/46; B07B 13/16

(52) U.S. Cl. CPC B02C 13/284; B02C 18/062; B02C 2023/165; B07B 1/469; B07B 13/16; B07B 1/06

(57) ABSTRACT

A sieve system for a grinding device permitting the processing of materials in terms of particle size, in particular the processing of solid or powder materials. The system includes a filtering portion having fine holes and designed to cooperate with a rotor of the grinding device in such a way as to press the material to be ground through said filtering portion; and a support portion having large holes, which is able to reinforce the filtering portion. The sieve can be coupled to a vibratory device. The sieve system allows for the grinding method to be operated in continuous mode, with a material flow rate through the sieve up to 50% higher than that reached with a conventional sieve.

### TECHNICAL FIELD

The present invention relates to a sieve/screen system for a device for grinding materials, in particular for powder materials, which allow a better flow of material through the sieve/screen during the grinding operation. The invention also relates to a grinding device comprising such a sieve system.

### STATE OF THE ART

Generally speaking, the known grinding treatment systems of a material such as a solid or powdered substance intended for the manufacture of a pharmaceutical, food or other product use a rotor mounted rotatably against a filtering portion or sieve. The material to be granulated is pressed between the rotor and the sieve. The sieve or screen is typically designed in two or more elements, for example a canvas and a frame, connected by different chemical (adhesive) or mechanical (welding) means.

The sieve is used to sort the ground material as it flows through the sieve. The sieve is generally composed of a screening cloth surrounded by a frame, or else welded sheets. The fragility of thin sheets requires that they be supported by thicker sheets, forming a rigid frame. This connection between the thin sheet and the thicker one of the frame is however not ideal when combined with the use of the rotor pressing the material against the sieve.

A sieve architecture in several interconnected components generates a fragility of the sieve. In fact, during the grinding operation in which the material is pressed against the sieve, the welds between the sheets can be weakened, leading potentially to a risk of deterioration of the screen. Indeed, the manufacture of sieves for a grinding machine is conventionally obtained by welding between a perforated sheet of small thickness in order to let the treated materials pass to a thicker plate serving as cradles. The two metal plates are thus bonded by mechanical or chemical means, which can be described as fragile or of little effectiveness, since their connection, whatever it maybe, can be deteriorated by the weight of the materials treated. Such an arrangement also favors a high retention rate of the materials. The ground material can therefore seep into interstices between the perforated sheet and the thick sheet. This may increase the clogging effect of the ground material in the sieve.

Patent application FR2682050 relates to a sieving device comprising a support chassis carrying at least one vibrating body equipped with a frame carrying a screen cloth. The frame is in the form of a rigid structure which carries a screen cloth. The screen cloth is bonded to this frame by means of a glue joint. A sonotrode coupled to an electro-acoustic converter is secured to the frame by means of screws. The ultrasonic vibrations generated by the sonotrode are transmitted to the canvas via the frame and the glue joint. Since the displacement which can be given to the screen fabric is limited for mechanical reasons, the increase in acceleration must therefore result from the increase in the frequency of the vibration. It is therefore of interest to superpose onto the so-called mechanical vibration of the screen cloth an ultrasonic vibration whose frequency is between 16,000 and 40,000 Hz. This document therefore refers to a sieving device in two parts, wherein the screen is attached to the frame of the sieve by gluing.

Such a screen architecture does not allow for a fully efficient transmission of vibrations.

Document WO13004229 proposes a screen frame for an ultrasonic sieve which comprises an upper face for fixing a screen cloth, a lower face opposite the upper face, and an opening surrounded in the frame of the screen. The frame of the sieve includes at least one groove extending around the opening so that the portion of the frame which is located in the edge of the groove faces towards the opening, and the opening forms an acoustic canvas conductor which is at least partially decoupled from the rest of the frame, from the point of view of ultrasound transmission. The architecture of the sieve is here composed of two or more structured parts.

WO08040540 relates to a device for activating a filter fabric surrounded by a filter frame by means of ultrasound. The ultrasound means comprises a transition piece and/or an ultrasound conductor, and means for introducing the ultrasound into the filter fabric, in particular an ultrasonic conductor. The ultrasonic transport system travels through a passage through the filter frame and is attached thereto. The sieve is non-metallic, it resides in a two-part device comprising, on the one hand, a filtering fabric and, on the other hand, a filter frame.

Patent application FR2768948 proposes a device for assisting the sieving and unclogging of the fabric of a sieve which comprises a vibrating structure which is in contact with the screen fabric and which is vibrated by a wave generator, in particular an ultrasonic generator. This structure consists of a part having in cross-section the shape of an inverted L with a base and a shoulder; the lower face of said base is connected to the generator and at least the end of the shoulder is in integral contact with the fabric, which protrudes on either side of the base. The sieve discussed herein is a non-metallic, two-part device attached to a wave generator.

WO2011066283 relates to a perforated plate for a vibrating screen, wherein the perforated plate comprises a base plate comprising a plurality of openings formed through it and a flange integrally formed with the base plate. The sieve itself is not foamed of one part with the perforated plate.

However, the documents cited above are confined to the use of sieves made up of several elements.

To overcome these various disadvantages, the invention provides various technical means.

### BRIEF SUMMARY OF THE INVENTION

First of all, a first object of the invention consists in providing a sieving system for a grinding process, in particular for solid or powdery materials, making it possible to carry out the grinding process in continuous flow mode.

Another object of the invention allows the grinding of powder materials with a fluid circulation of the powder materials, avoiding any risk of stagnation thereof in the sieve. i.e. by reducing as much as possible the clogging of the ground material in the sieve.

Still another object of the invention consists in providing a configuration of the sieve which makes it possible to limit the risks of deterioration of the sieve when vibrations are transmitted on its structure in order to facilitate the flow of the powder materials.

A further object of the invention is also to guarantee the optimum transmission of ultrasonic vibrations exerted on the sieve.

To do this, the invention provides a sieving system for a grinding device, comprising:

a filtering portion having fine holes and designed to cooperate with a rotor of the grinding device in such a way as to press the material to be ground through said filtering portion;

a support portion enabling the filtering portion to be reinforced;

the two parts constituting a single-piece element.

According to such a configuration, the monobloc sieve has advantageous characteristics. A single-piece arrangement makes it easy for powder materials to be circulated in the course of a grinding treatment, greatly reducing the risk of stagnation or clogging of materials. Such a configuration also makes it possible to avoid the risk of deterioration of the object when vibrations are exerted on it continuously. The use of a single-piece sieve makes it possible to increase the grinding efficiency and to reduce the micro heating. In addition, such a sieve configuration allows a grinding treatment system to be considered for various categories of solid or powder materials.

According to one advantageous embodiment, the sieve constitutes a single-piece element in which the filtering portion is integral with the support part. This single-piece and single-material configuration makes it possible to optimize the level of transmission of the frame to the filtering portion, in order to improve the overall efficiency of the grinding system.

According to another embodiment of the invention, the sieve constitutes a single-piece element which is made of a metal alloy.

According to an advantageous variant, the support consists of a surface provided with a plurality of openings, each being provided with a filtration zone having openings adapted to this function.

Advantageously, the single-piece element is obtained by chemical machining using specific masks.

According to another embodiment, the chemical machining is preferably carried out by placing a raw plate in a chemical bath on which are applied masks dimensioned respectively for the support part and for the filtering portion.

Advantageously, the sieve is connected by a connector ring to a vibration generator facilitating the continuous flow of powder materials through the filtering portion.

The invention also provides a grinding device comprising a sieve made of a single-piece element. Vibrations generated by a vibration generator may be exerted on the sieve, wherein the whole forms an integral part of an enclosure, grouping together the functional elements of said device.

### BRIEF DESCRIPTION OF THE DRAWINGS

Exemplary embodiments of the invention are indicated in the description illustrated by the attached figures in which:

FIG. 1 is a view of the plate forming the sieve, after perforation of the multiple openings and delimitation of the support;

FIG. 2 is a perspective view of a part of the single-piece sieve included in a grinding device, according to one embodiment;

FIG. 3 is a sectional view of a sieve system included in a grinding device according to another embodiment; and

FIG. 4 is a perspective view of the functional assembly of the grinding device comprising the sieve system outside the enclosure of the grinding device, according to another embodiment.

### EXAMPLE(S) OF EMBODIMENTS OF THE INVENTION

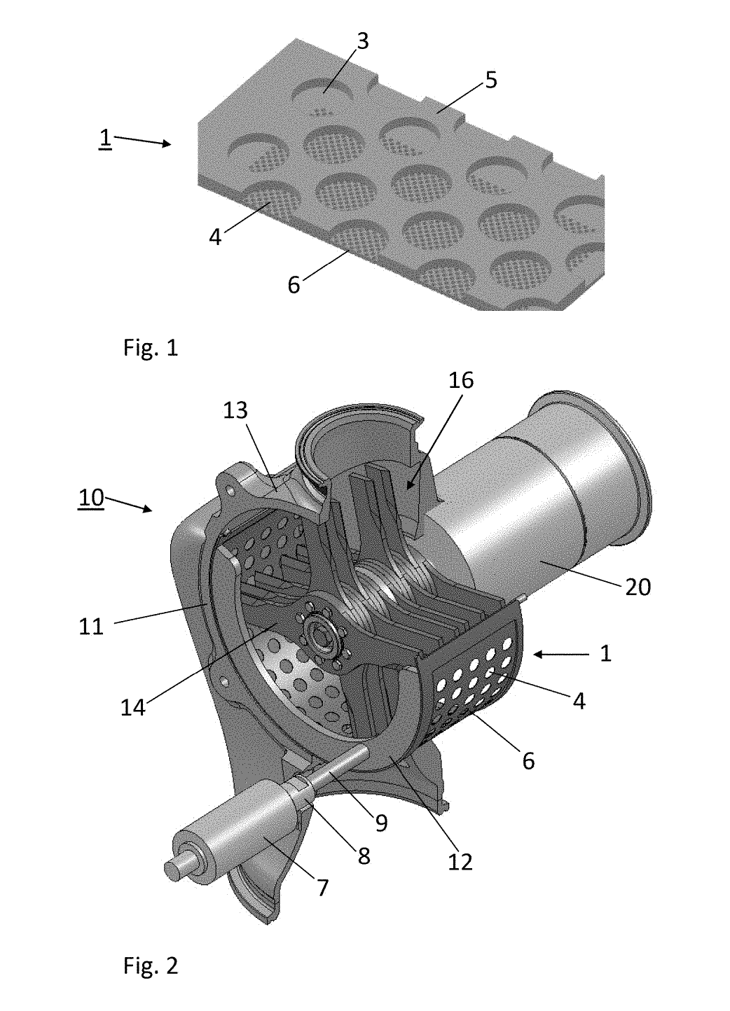

FIG. 1 illustrates an exemplary embodiment of a sieve 1 for a grinding device, in a perspective view where the sieve is shown flat. The single-piece sieve 1 is made of a metal alloy material, composed of a filtering portion 6 and a support part 5 arranged to form in a single block. The support part 5 is provided with large openings 3 in which the elements of the filtering portion 6 are shown. The support part constitutes a thick and solid element, providing the sieve 1 with a certain rigidity. The filtering portion 6 is composed of fine openings 4 in order to facilitate a fluid flow of material flow. Such a single-piece sieve arrangement 1 makes it possible, as opposed to prior sieves consisting of several glued or welded elements, to prevent the powder materials from being able to slip into cavities which do not exist in this architecture. The shapes and dimensions specific to the different openings of the single-piece sieve are here represented in circular form; however, the rounded form is not exhaustive since a multitude of shapes can be envisaged to fulfill the same function.

FIG. 2 is a perspective view of a part of the single-piece sieve 1 included in a grinding device 10 of the hammer grinder type. in the illustrated example, the grinding device 10 comprises an enclosure 11 which defines a grinding chamber 16 which can be filled with the material to be ground, a rotor assembly 14 rotatably mounted in the enclosure 11, and a sieve 1 to split the crushed material by the rotor assembly 14, which moves and unfolds below the rotor assembly 14. A driver unit 20 is designed to control the movements of the rotor assembly 14 relative to the sieve 1 during the grinding operation.

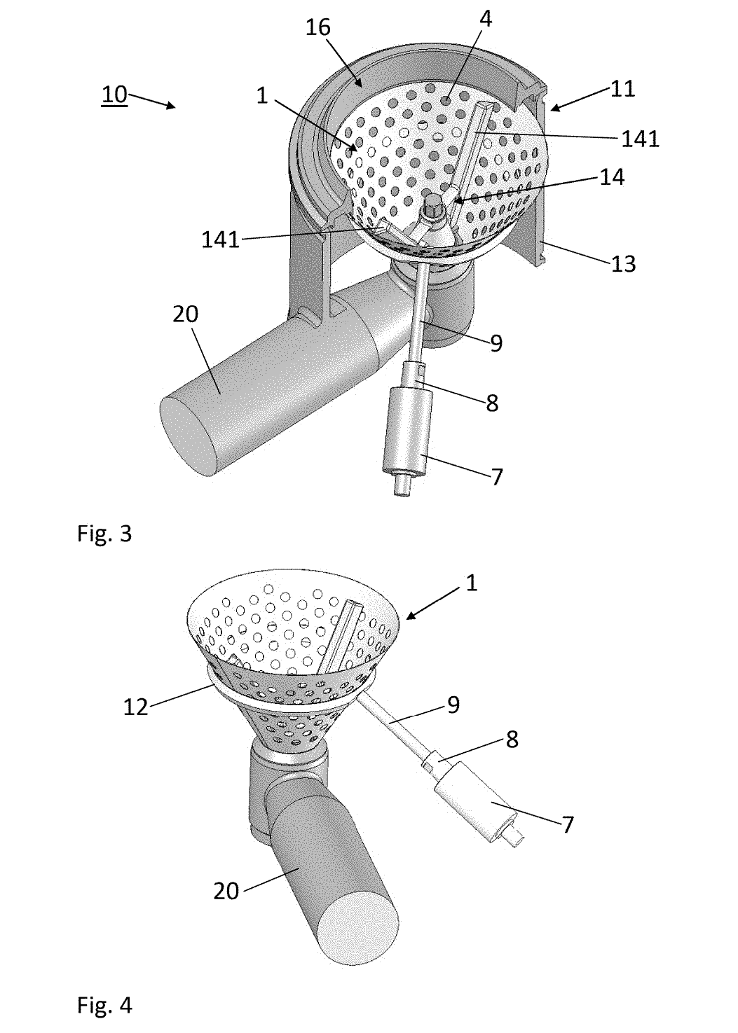

FIG. 3 illustrates another example of a grinding device 10 as a whole, in this case a conical sieve type shown in section, using a single-piece sieve 1 as described above. This system is integrated in a tubular protective housing 11 defining the grinding chamber 16 and wherein the sieve 1 is mounted coaxially. The sieve 1 is a truncated cone shape which tapers downwards. A rotor assembly 14 is rotatably mounted in the sieve 1. In the configuration illustrated in FIG. 3, the rotor 14 comprises two symmetrical grinding blades 141 arranged so that the space between each blade 141 and the sieve is essentially constant. During a grinding operation, the rotor 14 rotates relative to the inner wall of the sieve 1 so as to press the grinding material from the top of the chamber 16 against the sieve 1 and pass it through the openings 4 of the sieve 1.

The protective enclosure 11 enables the functional assembly of a powder material grinding system to be arranged in a closed and protected environment so that the grinding process can be carried out under specifically controlled conditions. In the example illustrated, the enclosure 11 is delimited by a wall 13 whose dimensions are adapted as a function of the volume required to accommodate the functional assembly of the grinding system.

The single-piece sieve 1 shown in the various figures, at various angles, is a single-piece sieve 1 made of a metal alloy. This single-piece element is obtained by a specific manufacturing process by chemical machining which is opposed to the sieve manufacturing process known in the prior art.

The manufacture of the single-piece sieve is made possible by chemical machining. A raw plate is immersed in a chemical bath. Different masks are used on both sides of the plate. The depths of the perforations are then precisely managed in order to obtain a filtrating part 6 with fine openings on one side 4 and a support part 5 with wide openings 3 on the other.

In one embodiment, the single-piece sieve 1 is coupled to a vibration generator 7 by means of a connector ring 12 surrounding the sieve 1. Such a configuration has the effect of facilitating the flow of the ground material through the sieve 1. The effect of the vibration makes it possible to prevent the material from agglomerating in the openings 4 of the sieve 1 during the grinding operation, thus allowing a continuous flow of the ground material without human intervention. Indeed, the vibrations generated by the vibration generator 7 are transmitted to the filtering portion of the sieve 6 very efficiently. This results in an acceleration of the circulation of the ground material, in particular by avoiding the risk of stagnation of the powder materials. The single-piece architecture also prevents the sieve from becoming fragile through the vibrations exerted since the latter is devoid of any bonding or welding zones.

In the examples illustrated in FIGS. 2 and 3, the vibration generator 7 is coupled to the connector ring 12 via a vibration-conducting arm 9 and an adapter 8, or connector. FIG. 4 is a perspective view of the same grinding system as that of FIG. 3, but in which the elements inside the protective enclosure 11 are shown outside it, in order to visualize more precisely certain functional elements of the vibration chain, and in particular the vibration transmitting ring 12.

The coupling of the vibration generator 7 to the sieve 1 can be ensured by a configuration other than that of the connector ring 12 illustrated in FIGS. 2 and 4. For example, the vibration generator 7 can be coupled directly to the support part 5 of the sieve 1. In FIG. 3, the vibration generator 7 is coupled to the sieve 1 by means of an arc 12 disposed at one end of the sieve 1 of cylindrical shape.

The chamber 11 not only permits grinding of powder materials in a healthy and opaque environment but also serves to collect the powder materials which have passed through the single-piece sieve 1. The system for grinding powder materials by means of grinding thus permits a continuous treatment of the materials without human intervention, by virtue of the combination between the single-piece screen 1 and the vibration device 7, 8, 9. The dimensions of the enclosure 11 are also advantageously defined so as to take account of the vibration device connected to the sieve.

In a grinding process with the sieve system 1 comprising the vibration generator 7, the flow rate of the material through the sieve can be up to 50% higher than the flow achieved by using a sieve comprising two or several parts and in the absence of vibration exerted on the sieve. There is therefore less retention of material in the grinding chamber, thereby improving the efficiency of the grinding operation. Other advantages include the lower temperature generated by the grinding operation and less power to rotate the rotor during the grinding operation.

The treatment system previously described is advantageously used in the context of a process for treating materials, in particular powder materials, with steps involving mechanical operations carried out on the material, such as, for example, sieving, centrifuging, weighing, sorting, grain-sizing, or other mechanical operation. The process is particularly suitable for powder materials, without excluding other forms of material, for example granulates.

The figures and their descriptions given above illustrate the invention rather than limit it.

The references in the claims are not limiting. The verbs “to comprise” and “to include” do not exclude the presence of elements other than those listed in the claims. The word “one”/“a(n)” preceding an element does not exclude the presence of a plurality of such elements.

### REFERENCE NUMBERS USED IN THE FIGURES

1 sieve
10 grinding device
11 enclosure
12 ring connector
13 wall
14 rotor assembly
141 grinding blades
16 grinding chamber
20 driver unit
4 openings
5 support part
6 filter part
7 vibration generator
8 connector
9 driver arm

What is claimed is:

1. Sieve system for a grinding device, comprising:
a filtering portion having fine holes and designed to cooperate with a rotor of the grinding device in such a way as to press the material to be ground through said filtering portion); and
a support portion enabling the filtering portion to be reinforced, wherein the support portion is provided with openings comprising the elements of the filtering portion;
the filtering portion being integral with the support part.

2. Sieve system according to claim 1, wherein the filter portion and the support part are made of a metal alloy.

3. Sieve system according to claim 1, wherein the support is constituted by a surface provided with a plurality of openings, each provided with a filtration zone having openings adapted to this function.

4. Sieve system according to claim 1 being connected by a connector ring to a vibration generator facilitating the continuous flow of powder materials through the filtering portion.

5. Grinding device comprising a sieve system comprising a filtering portion having fine holes and designed to cooperate with a rotor of the grinding device in such a way as to press the material to be ground through said filtering portion, a support portion enabling the filtering portion to be reinforced; the support portion being provided with openings comprising the elements of the filtering portion; the filtering portion being integral with the support part.

6. Method of manufacturing the sieve system comprising a filtering portion having fine holes and designed to cooperate with a rotor of a grinding device in such a way as to press the material to be ground through said filtering portion, a support portion enabling the filtering portion to be reinforced; the support portion being provided with openings comprising the elements of the filtering portion; the filtering portion being integral with the support part;
the method comprising the steps of applying masks respectively sized for the support part and the filter portion to a raw plate and placing the raw plate with masks in a chemical bath.
